(19) United States
(12) Patent Application Publication
(10) Pub. No.: US 2026/0243604 A1
(43) Pub. Date: Aug. 20, 2026

(54) METHOD AND DEVICE FOR THE THERMOGRAPHIC AND TOPOGRAPHICAL CHARACTERISATION OF INHOMOGENEITIES IN THE LAYER STRUCTURE OF COATED SUBSTRATES

(71) Applicant: ORONTEC GmbH & Co. KG, Dortmund (DE)

(72) Inventors: Karl-Friedrich DOESSEL, Wuppertal (DE); Ralph Jan WOERHEIDE, Wuppertal (DE); Hans Hendrik HUSTERT, Dortmund (DE)

(73) Assignee: ORONTEC GmbH & Co. KG, Dortmund (DE)

(21) Appl. No.: 19/161,352

(22) PCT Filed: Mar. 7, 2024
(86) PCT No.: PCT/EP2024/056042

§ 371 Date: Sep. 2, 2025

(30) Foreign Application Priority Data
Mar. 10, 2023 (DE) 10 2023 106 020.1

(51) Int. Cl. G01J 5/48; G01B 11/02; G01B 11/06; G01J 5/00; G01J 5/03; G01J 5/08

(52) U.S. Cl. CPC G01J 5/48; G01B 11/022; G01B 11/0608; G01J 5/03; G01J 5/0859; G01J 5/0896; G01J 2005/0077

(57) ABSTRACT

A method and a device for the thermographic characterization of the surface of a coated workpiece in which a thermogram is produced of one or more first surface portions of the surface, and an image is produced of one or more illuminated second surface portions of the surface, at least some of the one or more first and second surface portions extending over a common region of the surface. In addition to the spatial extent of an inhomogeneity in the layer structure determined using the thermogram, a height profile of the surface is also determined. To this end, the illuminated region of the surface, of which a thermogram and an image are created, is illuminated such that the image provides a height profile of the surface.

### TECHNICAL FIELD

The invention relates to a method for the thermographic characterization of the surface of a workpiece, in particular a coated workpiece, in which a thermogram is generated of one or more first surface sections of the surface and an image is generated of one or more illuminated second surface sections of the surface, wherein at least some of the one or more first and second surface sections extend over a common region of the surface.

Furthermore, the invention relates to an apparatus for carrying out the method, with a thermography device which has an energy emitter and a sensor for generating a thermogram, with a light source for illuminating the surface of the workpiece, with a sensor assembly for recording an image of the illuminated surface and with a device for the relative displacement of the workpiece with respect to the sensor assembly and the thermography device.

### PRIOR ART

DE 10 2017 003 175 A1 describes an automated method and an apparatus for assessing corrosion damage on coated surfaces of metal substrates. The metal substrates are provided with a layer of paint. The paint layer is damaged at defined locations. In particular, using a scratching tool, the paint layer is artificially damaged in the form of a scratched line. The workpiece which has been pre-treated in this manner is then brought into a corrosive atmosphere, for example by spraying with saltwater, for a predetermined time period. During this treatment, corrosion occurs in the region of the damage which spreads out under the paint layer during the course of the treatment period. This leads to inhomogeneities in the structure of the paint layer, for example in the form of a delamination of the paint layer and substrate. In most cases, this also results in bulging of the paint surface, which can be identified using sensitive optical methods. In a standardized method for determining the extent of these inhomogeneities which has been employed up to now, the paint layer is mechanically removed, for example with a wire brush. The widths of a visible inhomogeneity are measured transversely to the scratched line at certain points at distances of a few millimeters. A mean value is formed therefrom. In the document cited above, an automated method is specified, with which the inhomogeneities in the layered structure can be measured automatically with the aid of pulsed thermography. Furthermore, the measurement region for the pulsed thermography is defined with the aid of a visual image produced by a camera. In order to draw conclusions regarding the type of corrosion, in addition, the color values for each individual pixel of the visual image are determined and compared with the thermogram in order to classify inhomogeneities such as corrosion damage, for example, in the layered structure. In practice, the standard EN ISO 6428-8 is used to assess corrosion damage.

Furthermore, the prior art contains methods with which reflective surfaces, or at least sufficiently light-reflective surfaces, can be measured in a contactless manner. This in particular includes photometry, radiometry, photogrammetry, laser scanning, reflectometry, deflectometry and dark field illumination. This method enables a height profile of a surface to be determined.

### SUMMARY OF THE INVENTION

The problem of the invention is to further develop the generic method in a manner which is advantageous for use. The invention shall provide supplemental information for the characterization, in particular for a topographical characterization, of inhomogeneities in the layered structure of coated substrates, in particular metal substrates.

The problem is solved by the invention defined in the claims. The dependent claims not only constitute advantageous further embodiments of the invention defined in the subordinate claims, but also constitute distinct solutions to the problem.

First and foremost, it is proposed that, in addition to the spatial extent, determined with the thermogram, of an inhomogeneity in the layered structure of a coated substrate, for example a glass substrate, a cement substrate or, preferably, a metal substrate, a height profile of the surface is also determined. The method in accordance with the invention is particularly suitable for the analysis of corrosion damage in paint samples. To this end, a substrate, in particular a metal substrate, is provided with a paint layer. The paint layer is damaged at a defined location. The sample which is prepared in this manner is exposed to a corrosive atmosphere, for example salt water, for a predetermined time period. The corrosion produced thereby, which infiltrates the paint layer, is examined with the pulsed thermography method. The surface is heated for a few milliseconds at high power at first surface sections with a beam of energy, in particular a laser beam. The dissipation of heat into the substrate will be influenced by the layer of corrosion formed between the substrate surface and paint layer. Consequently, conclusions can be drawn about the corrosion located under the paint layer from the temperature of the first surface section measured with a sensor, for example an infrared sensor or an infrared thermography camera or a thermal imaging sensor. The infrared sensor can measure an “array” of pixels. Preferably, the “array” contains at least 8×16 pixels. The application of the energy beam to the paint surface may be carried out in pulses; as an example, the temperatures after application of the pulse with the laser beam at mutually different first surface sections can be measured successively. However, it is also possible to pass a continuous or rapidly pulsed laser beam continuously over the surface in order to simultaneously measure the profile of the temperature with respect to time at the respective illumination point with an infrared camera which records a plurality of images one after the other. In accordance with the invention, this method is supplemented by recording a height profile of the surface. To this end, a respective height profile is determined at second surface sections. The second surface sections contain at least a few or a plurality of the first surface sections. Thus, the height profile is also determined at a region of the surface at which the thermographical investigation is also being carried out. The height profile can be recorded at the same time as the thermographical investigation. However, it may be recorded beforehand or afterwards. An apparatus in accordance with the invention, which to this end has a thermography device, has an additional sensor assembly and a light source. The surface of the workpiece is illuminated with the light source in a manner such that the height profile can be determined with the associated additional sensor assembly. The height profile can be brought into a spatial correlation with the thermogram with a computing device, which in particular comprises an image recognition device. In this regard, the height values of the height profile are locally associated with the temperature values of the thermogram. The height profile and the thermogram are recorded at a plurality of first or second surfaces, wherein for some, preferably for all of the surface sections at which a thermogram has been generated, i.e. a temperature has been measured, a height value for the surface is also optically determined. In this regard, the workpiece can be displaced in an automated manner relative to a measuring device. To this end, the measuring device preferably has the energy emitter, the temperature-detecting sensor, the light source and the sensor assembly for recording an image of the illuminated surface. In accordance with the invention, the type of illumination is selected such that predictions about the height of the inhomogeneity, for example the bulging of a paint layer in the region of corrosion damage, can be made. To this end, in particular, the Phase Shifting Deflectometry (PSD) method, laser triangulation method, or in fact also the dark field illumination method is used as the optical/visual method. To this end, a visual image of the coated surface can be produced by means of a camera, wherein the type of illumination and the evaluation of the visual image of the coated surface enables the thermal image to be correlated with color values and a height profile. The color values can be recorded with a camera which captures a visual image and enables conclusions to be drawn regarding the type of inhomogeneity. As an example, rust or the formation of aluminum oxide can be detected with the aid of the color. Preferably, a painted metal substrate, and in particular an iron-containing substrate, comes into consideration as the substrate. What is essential for the thermographic method is a difference in the thermal capacity and/or the thermal conductivity between the coating and substrate, so that the method can also be applied to coated substrates produced from other substances.

### BRIEF DESCRIPTION OF THE DRAWINGS

Exemplary embodiments of the invention will now be described with the aid of the accompanying drawings, in which:

FIG. 1 schematically shows, in a perspective view, a first exemplary embodiment of an apparatus for carrying out the method, in which the height profile is determined by laser triangulation,

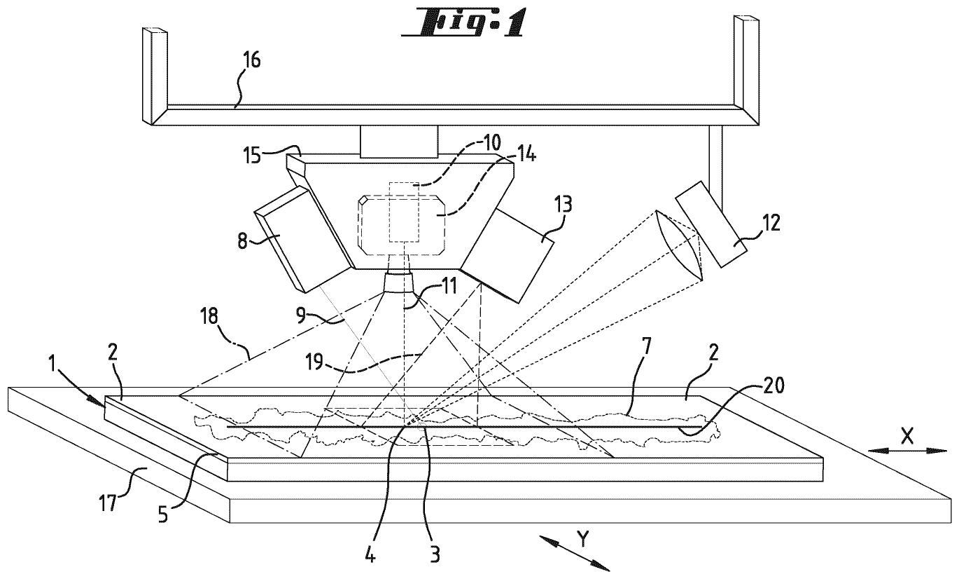

FIG. 2 schematically shows, in a two-dimensional view, a second exemplary embodiment of an apparatus in which the height profile (shown greatly enlarged in the drawings) has also been determined by laser triangulation,

FIG. 3 shows a view similar to FIG. 1 of a third exemplary embodiment in which the height profile is determined by deflectometry,

FIG. 4 shows a two-dimensional view of the apparatus shown in FIG. 3, and

FIG. 5 shows a view of a fourth exemplary embodiment in which the height profile is determined by dark field illumination.

### DESCRIPTION OF THE EXEMPLARY EMBODIMENTS

A support 15, which carries an infrared laser 8 which produces a laser beam 9 which impinges on a workpiece 1 at a first surface section 3 is fastened to a frame 16 which can be fixed in position, for example in a laboratory. A thermal image of a capture region 19 can be recorded with a sensor 13 fastened to the support 15, the sensor 13 possibly being a thermal imaging sensor, with which a section of the surface 2 of the workpiece 1 located in the capture region 19 can be measured. The infrared laser 8 generates a laser beam 9 with a wavelength which lies outside the sensitivity range of the sensor 13, so that the temperature of the first surface section 3 heated by the application of the energy can be determined with the sensor 13.

The dissipation of heat from the surface into the volume of the workpiece influences the temperature.

Furthermore, the support 15 has a camera 14 with which a visual image of the surface 2 of the workpiece 1, in particular also containing color values, can be recorded. In the exemplary embodiment, the capture region 18 of the camera 14 is somewhat larger than the capture region 19 of the sensor 13.

A second surface section 4 of the surface 2 is illuminated with a further laser 10. During the course of laser triangulation, the height of the surface section 4 can be determined with a further sensor assembly 12.

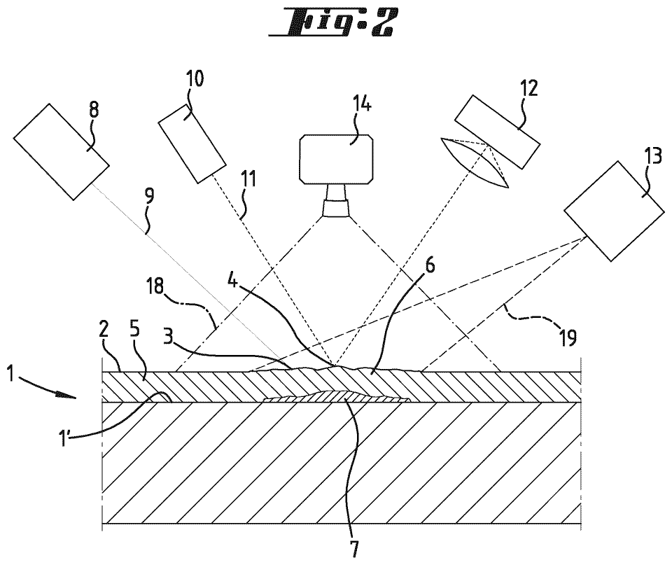

The following method can be carried out with this apparatus: damage 20 is caused to a metal workpiece 1 which has previously been coated with a paint layer 5, for example by introducing a scratched line which reaches to the metal surface 1′ into the paint layer 5. The workpiece 1 is then exposed to a corrosive environment in a climatic chamber for a predetermined period of time. This forms corrosion damage 7 in the region of the damage 20, which also migrates under the paint layer 5 (see FIG. 2).

The workpiece 1 which has been treated this manner is placed on a support 17 which can be displaced relative to the frame 16 by an automated control device, not shown here. In correspondence with the method described in the aforementioned DE 10 2017 003 175 A1, a thermogram is recorded at a plurality of predetermined first surface sections 3, with which conclusions can be drawn regarding the delamination of the paint. In detail, a sensor 13, in particular a thermal imaging camera, is used to examine what temperature the first surface section illuminated by the laser beam 9 heats up to during the illumination, or how the temperature varies after the illumination.

At the same time, a height profile is recorded at the same surface sections or at other surface sections which will be referred to below as second surface sections 4. Values are determined which provide the respective height of the surface of the paint layer 5 or its distance from the metal surface 1′. The measurement points for the thermography are correlated with the measurement points for the height measurement with the computing device, not shown, which may have an image recognition device, so that some, preferably all of the measurement sites at which temperatures have been measured by the thermography, are also provided with height values.

Here, the workpiece 1 can be displaced in the X-direction and/or Y-direction with respect to the support 15 by stepping motors. However, it is also possible for the support 15 to be displaced with respect to the frame 16, for example in the X-direction, and for the support 17 to be displaced in the Y-direction with respect to the frame 16. By means of an appropriate control of the stepping motors, the laser beam 9 can be displaced line by line over the workpiece 1. Along with this, the measurement point or the measurement location of the sensor assembly 12 is also displaced over the surface of the workpiece 1. A surface contour of the corrosion damage 7 can then be determined with this method.

The optical axis of the laser beam 11 can be perpendicular to the surface 2 here.

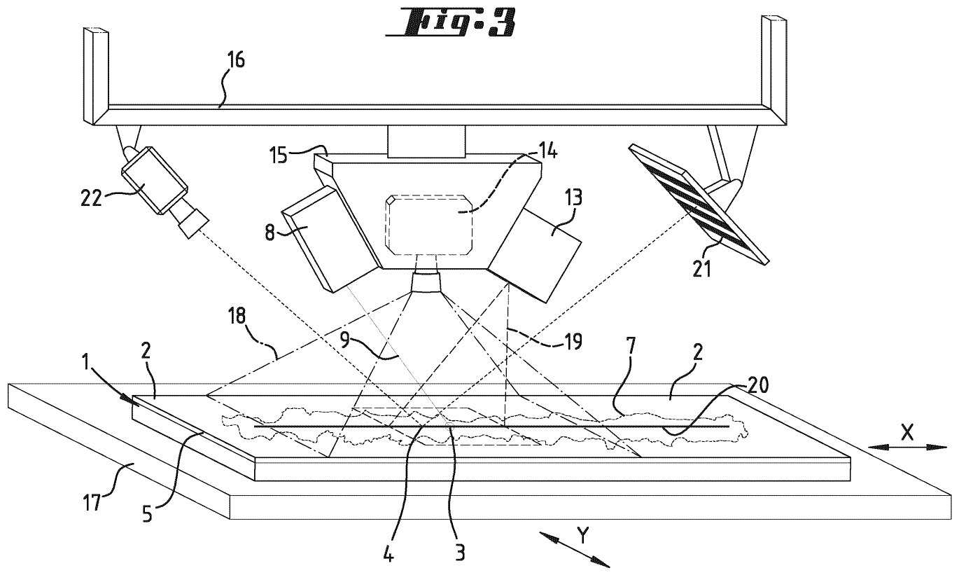

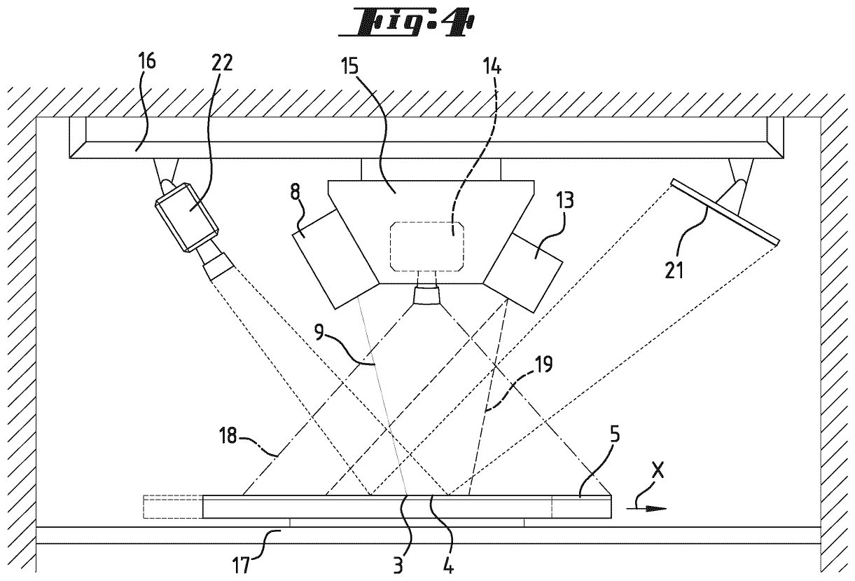

The exemplary embodiment shown in FIGS. 3 and 4 essentially differs from the exemplary embodiment described above by the method for determining the height profile. Here, the height profile is determined using the deflectometry method. A two-dimensional image 21 with a defined structure is generated on a display screen, which image is displaced in a defined manner over the display screen, so that with a sensor assembly, which is formed here by an optical camera 22, a surface region of the surface 1 at which the movable image 21 is reflected can be observed. In the case of an ideal flat surface, the structures moving over the display screen would be captured undistorted by the optical camera 22. However, a surface which deviated from an ideal flatness will distort the image recorded by the optical camera 22 and then contains distortions compared with the movable image 21. By means of a comparative calculation with an image recognition device, in which the image recorded by the sensor assembly 22 is compared with the two-dimensional image 21, conclusions can be drawn as to the surface topology of the surface 2 from the deviations due to the distortions,. The height profile can be calculated from these images.

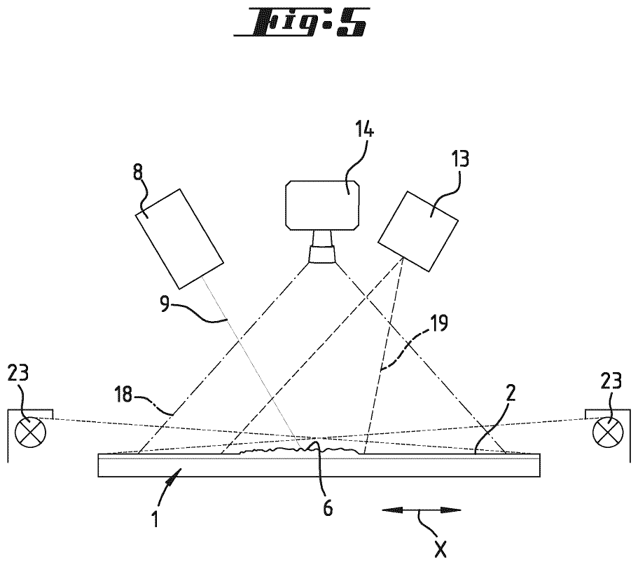

The exemplary embodiment shown in FIG. 5 differs from the exemplary embodiments described above essentially in the method for determining the height profile. Here, the height profile is generated with dark field illumination. The surface 2 is illuminated at a flat angle by means of the light source 23. An image of the region which is illuminated in this manner is recorded with the camera 14. The image is evaluated with the image recognition device. The height profile can be calculated from the image.

The optical axis of the camera 14 here can be perpendicular to the surface 2. The height profile can be recorded using visible light. However, it is also possible to record the height profile with non-visible light, for example infrared light or ultraviolet light.

Furthermore, visual images of the surface 2 can be recorded in all of the exemplary embodiments described above. In particular, this can be carried out with the visual camera 14. The visual camera 14 may be sensitive to visible light. However, it may also be sensitive to infrared or ultraviolet light. The images recorded in this manner preferably contain color information, so that the color of the corrosion damage 7 can be analyzed. Conclusions can thereby be drawn regarding the type of inhomogeneity in the layered structure.

The above discussions serve to explain the inventions covered in the application, which further develop the prior art at least by the following combinations of features as well as independently, wherein two, more or all of these combinations of features may also be combined, namely:

A method, which is characterized in that the region is illuminated in a manner such that the image provides a height profile of the surface.

A method, which is characterized in that the thermogram and the height profile are brought into a spatial correlation.

A method, which is characterized in that the height profile is determined with the laser triangulation method, the dark field illumination method or the deflectometry method.

A method, which is characterized in that the workpiece 1 has a paint layer 5 applied to a surface 1′ of a substrate and is exposed to a corrosive environment for a predetermined period of time in a manner such that inhomogeneities 6, 7 are formed in the layered structure, wherein the first and second surface sections 3, 4 are located in the region of the inhomogeneities 6, 7, wherein in particular, the inhomogeneity is a delamination of paint layer 5 and substrate or a further impairment of the paint layer 5.

A method, which is characterized in that images containing color values from at least the region of the surface 2 are produced, which are brought into a spatial correlation with the height profile.

An apparatus, which is characterized in that the light source 10, 21, 23 is constructed and disposed in a manner such that the image provides a height profile of the region of the surface.

An apparatus, which is characterized by an image recognition device with which the thermogram recorded by the thermography device 8, 13 and the image recorded by the sensor assembly 12, 22, 14 are brought into a spatial correlation in an automated manner.

An apparatus, which is characterized in that the light source has one or more lasers 10 and the sensor assembly has one or more sensors 12 which are sensitive to the light from the laser reflected from the surface or in that the light source 22 provides a two-dimensional image which varies with time and the sensor assembly is a camera 22 which captures the image reflected at the surface or in that the light source 23 illuminates the surface 2 at a flat angle and the sensor assembly 14 is a camera which captures a visual image.

An apparatus, which is characterized in that the sensor assembly comprises a camera 14 with which images containing color values for at least the illuminated region of the surface 2 are produced, and the image recognition device is configured in a manner such that with it, the images containing color values can be brought into a spatial correlation with the height profile.

All of the disclosed features (alone, but also in combination with each other) are essential to the invention. In the disclosure of the application, the contents of the disclosure of the associated/accompanying priority documents (text of priority application) are herewith incorporated in full by reference, also for the purposes of including features of these documents in claims of the present application. Even without the features of a claim under consideration, the features of the dependent claims characterize independent inventive further developments of the prior art, in particular for the purposes of making divisional applications on the basis of these claims. The invention defined in each claim can additionally have one or more of the features specified in the present description, in particular features provided with reference numerals and/or in the list of reference numerals. The invention also concerns embodiments in which individual features mentioned in the present description are not put into effect, in particular when they are clearly unnecessary for the respective intended use or can be replaced with other means that have the same technical effect.

### LIST OF REFERENCE NUMERALS

1 workpiece
1′ metal surface
2 surface
3 first surface section
4 second surface section
5 paint layer
6 height structure
7 corrosion damage
8 infrared laser
9 laser beam
10 light source, laser
11 laser beam
12 sensor assembly
13 sensor
14 camera
15 support
16 frame
17 support
18 capture region
19 capture region
20 damage
21 two-dimensional image
22 sensor assembly, camera
23 light source

1. A method for the thermographic characterization of a surface (2) of a coated metal substrate (1) using a sensor (13), comprising generating a thermogram and an image of a region of the surface (2) of the coated metal substrate illuminated by an infrared laser (8) which produces a laser beam (9) with a wavelength which lies outside a sensitivity range of the sensor (13), wherein the region is illuminated in a manner such that the image provides a height profile of the surface.

2. The method as claimed in claim 1, wherein the thermogram and the height profile are brought into a spatial correlation.

3. The method as claimed in claim 1, wherein the height profile is determined with a laser triangulation method, the a dark field illumination method or the a deflectometry method.

4. The method as claimed in claim 1, wherein the workpiece (1) has a paint layer (5) applied to a surface (1′) of the substrate and is exposed to a corrosive environment for a predetermined period of time in a manner such that inhomogeneities (6, 7) are formed in the layered structure, wherein the first and second surface sections (3, 4) are located in the region of the inhomogeneities (6, 7), wherein in particular, the inhomogeneity is a delamination of the paint layer (5) and substrate or a further impairment of the paint layer (5).

5. The method as claimed in claim 1, wherein images containing color values from at least the region of the surface (2) are produced, which are brought into a spatial correlation with the height profile.

6. An apparatus for carrying out a method in accordance with claim 1, comprising: a thermography device (8, 13) which has a temperature control device and a sensor (13) configured for generating the thermogram, a light source (10, 21, 23) configured for illuminating at least one region of the surface (2) of the workpiece (1), a sensor assembly (12, 22, 14) configured for recording an image of the illuminated region of the surface (2) and with a device (17) configured for the relative displacement of the workpiece (1) with respect to the sensor assembly (12, 22, 14) and the thermography device (8, 13), wherein the light source (10, 21, 23) is constructed and disposed in a manner such that the image provides a height profile of the region of the surface (2) of the workpiece (1), wherein the temperature control device is an infrared laser (8) which is configured to produce the laser beam (9) which has the wavelength which lies outside the sensitivity range of the sensor (13), and which illuminates surface sections of the workpiece (1) during the displacement of the workpiece (1), wherein the sensor (13) is configured to measure a profile of the temperature at the illuminated surface section with respect to time during the illumination.

7. The apparatus as claimed in claim 6, further comprising an image recognition device with which the thermogram recorded by the thermography device (8, 13) and the image recorded by the sensor assembly (12, 22, 14) are brought into a spatial correlation in an automated manner.

8. The apparatus as claimed in claim 6, wherein the light source has one or more lasers (10) and the sensor assembly has one or more sensors (12) which are sensitive to the light from the laser reflected from the surface or wherein the sensor assembly (22) provides a two-dimensional image which varies with time and the sensor assembly is a camera (22) which captures the image reflected at the surface or wherein the light source (23) illuminates the surface (2) at a flat angle and the sensor assembly (14) is a camera which captures a visual image.

9. The apparatus as claimed in claim 6, wherein the sensor assembly comprises a camera (14) with which images containing color values for at least the illuminated region of the surface (2) are produced, and the image recognition device is configured for bringing images containing color values into a spatial correlation with the height profile.

10. (canceled)
